(19) United States
(12) Patent Application Publication
(10) Pub. No.: US 2011/0276153 A1
(43) Pub. Date: Nov. 10, 2011

(54) METHOD AND SYSTEM FOR FACILITATING GOLF SWING INSTRUCTION

(76) Inventor: Allen Joseph Selner, Manhattan Beach, CA (US)

(21) Appl. No.: 13/078,958

(22) Filed: Apr. 2, 2011

Related U.S. Application Data
(60) Provisional application No. 61/321,483, filed on Apr. 6, 2010.

(51) Int. Cl. A63B 69/36; G09B 19/00; G06F 19/00

(52) U.S. Cl. 700/91; 473/409; 434/252

(57) ABSTRACT

A method for teaching golf based upon comparing a commonality of personal characteristics of a student and the personal characteristics of a group of high-level golfers is contemplated herein. Data mining is used to determine clusters of golfers with common physical characteristics and commonality of swings, based upon real-time measurements. A canonical swing is developed for each desired cluster. Prospective students have their respective personal characteristics determined and used to place them in a cluster. The canonical swing of that cluster is assigned to the student. Subcomponents of performing a canonical swing are determined for instructional purposes. Biomechanical and Newtonian mechanics are used to measure the ball flight's sensitivity to each subcomponents' accurate performance and a scoring system is produced to provide a simple measure of students' state of mastering their respective canonical swings.

### RELATED APPLICATIONS

This application claims priority from U.S. provisional application 61/321,483 filed Apr. 6, 2010, which is hereby incorporated herein by reference in its entirety.

### FIELD

The field is related to athletic instruction, particularly golf instruction.

### BACKGROUND

Golf is played by a wide variety of individuals and also has been taught in many manners. Many golf instruction methods take the approach of coaching an individual to become proficient in performing a particular golf stroke style. Some instruction methods determine a stroke to be taught by averaging the actions of many elite golfers to produce an “ideal” swing for students to emulate. There are also existing techniques and devices for measuring the motions, forces, and kinetics that make up an instance of a swing. Known methods include comparing an instance of an executed swing to a desired swing and assessing closeness of the performance to the target model.

The cost of dynamic body motion and force measurement devices have lowered and biomechanical knowledge has increased. However, the wide array and complexity of possible human motions, the large amount of raw data, and particularly a lack of results that are useful without expert interpretation, have significantly limited the routine exploitation of the tools and techniques of this field by coaches and instructors. Teaching and learning golf remain difficult and potentially frustrating experiences. Instructors often base their teaching methods on their individual, widely divergent, ideas of the ideal swing.

### SUMMARY

A premise of these teachings is that particular swing types are suited to particular individuals and that an effective way to assign a swing type to an individual is based on that individual's personal commonalities with elite golfers employing particular swings. Elite golfers, by definition, each use a swing type that is successful for them. Further, some embodiments involve methods of teaching a student a particular swing and some embodiments can involve quantitative methods for assessing a student's progress. There are systems for instrumentation of movement that can provide volumes of data. However to make that data relevant to players, instructors, and coaches requires methods that provide understandable and actionable information which can be in the form of ratings relevant to the physical task of interest.

The teachings of this invention include measuring and capturing the motions and forces in swings of an elite set of golfers. Secondly, a wide range of physical and non-physical personal characteristics such a body type and demographic information can be determined regarding these golfers. Data mining techniques and other statistical analysis can be used to find clusters or correlations between measured swing data to personal attributes. Individual students can have their physiological and other personal characteristics determined and compared to that collected and analyzed from elite golfers. A close match between the common attributes of a cluster of elite golfers and a student's attributes can suggest a recommended swing for that student to learn.

Further, a model swing can be analyzed based on Newtonian mechanics and biomechanics to determine the sensitivity of broken down sub-aspects of executing the model swing has to accurate ball flight outcome. A single, weighted score can be produced reflecting a learner's progress toward their particular model swing using weighting based upon that sensitivity analysis. Preferably, the single score is relevant to repeated measurements of progress. Measurements consistent with the principle herein may involve measuring or deducing other variables such as Electromyogram (EMG) and Ground Reactive Force (GRF) information and may also involve static variables such as body type, demographic, physiological, static biomechanical factors, and psychological information.

### OVERVIEW OF DRAWINGS

FIG. 1 shows an exemplary golf instrumentation system with a golfer instrumented for motion data capture;

FIG. 2 shows an enlarged view of an instrumented glove for motion data capture;

FIG. 3 shows various regions of a golfer and golf equipment relevant to swing measurement;

FIG. 4 is a flowchart illustrating an exemplary process for creating a set of clusters of elite golfers with a commonality of swing style;

FIG. 5 is a flowchart illustrating an exemplary process for assigning a new golf student to a cluster and recommending a swing style;

FIG. 6 is a flowchart showing exemplary steps involved in training a student to execute a canonical swing they have been assigned;

FIG. 7 is a flowchart showing a sub process for gathering and organizing elite golfer data;

FIG. 8 is a flowchart showing a sub process for outputting a cluster report.

### DETAILED DESCRIPTION

An optimal golf swing would be one that produced maximum distance and accuracy of the trajectory of a golf ball. An “improper swing motion” is generally the major cause of inaccuracies resulting in slicing or hooking the ball or poor ball strike. These problems prevent the ability to obtain maximum distance and accuracy. Golfers also desire a swing that is consistently repeatable over time and over club type. However, it has been unclear what an “optimal” or even a successful swing consists of for a particular individual. Golf students have a wide range of physiological and other characteristics that leads to a range of swing styles that may be specifically appropriate to each of those varying students.

Methods consistent with the teachings herein for assigning a particular swing type to particular golf students include studying a variety of elite golfers with a range of body types and other characteristics. A swing optimal for a first golfer will not be the optimal swing for a second golfer with a very different body type. Tiger Woods, Jack Nickolas, and Arnold Palmer each use a swing that is optimized to hit the ball squarely with a maximum of momentum. However, the details of their swings are quite distinct as are their body types and athletic strengths and mental attitudes. Elite golfers have experimented with a variety of swing styles and settled upon one that is well suited to their personal characteristics including body type.

First Data Set

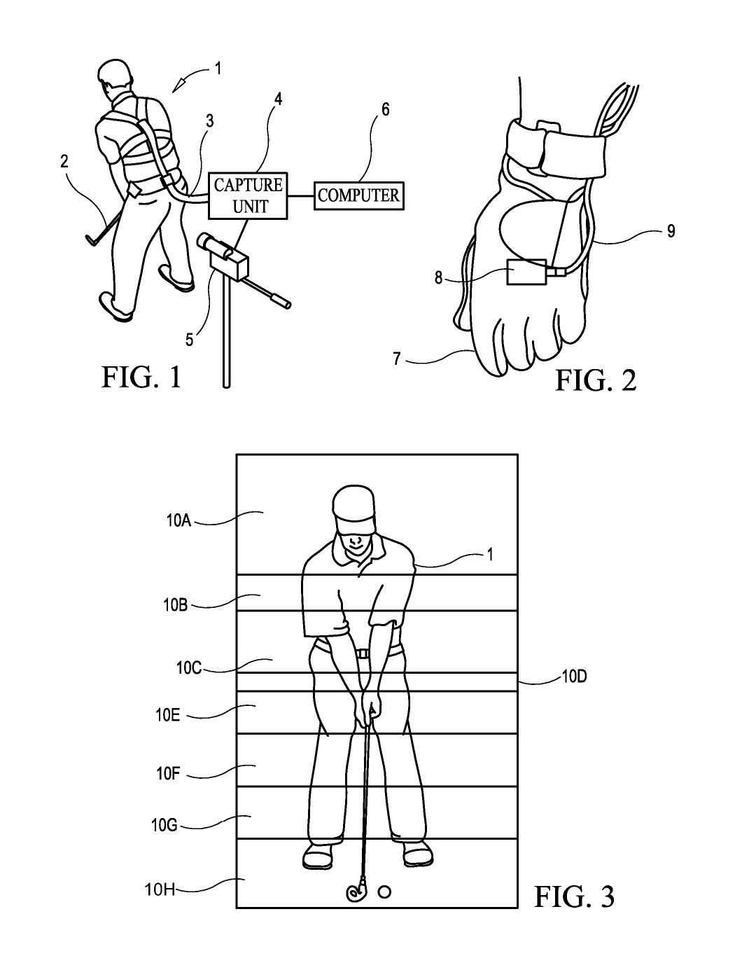

A set of elite golfers is broadly instrumented to make real-time measurements of positions, velocities, joint angles, GRF, and acceleration of points on their bodies while repeatedly performing their swing. FIGS. 1 and 2 illustrate examples of instrumenting for a golf swing. In FIG. 1 a golfer 1 holding a golf club 2 is instrumented with body transducers connected to a data capture unit 4 by cables. Also connected to the capture unit is a camera 5. The capture unit is connected to a computer system 6. FIG. 2 shows the detail of instrumenting hand motion using a glove 7 with a sensor 8 embedded within it. The sensor's signals proceed to a capture unit by wiring 9.

Other measurements can include the rate of change of shifting weight. The parameters indicative of golf swing type may include ball address, top of backswing, impact, and finish. The biomechanical factors derived from that measurement data might include kinematic variables related to physiological parameters and anatomic movement. They may include angle-angle relationships that relate the dynamic changes in one body angle, shoulder turn for example, to another angle, hip turn, for example. FIG. 3 provides an example of various body regions of a golfer 1 that might be independently tracked and compared. Movements and forces from head 10A to foot 10H as well as all of the regions 10B 10C 10D 10E 10F 10G in between can be relevant. In addition, the relative timing and sequencing of movements and rates of change can be correlated.

A multi-camera system can provide an apparatus to track the location of each small region of a golfer's body in real time via a 3D tracking system. In addition, a pressure plate the golfer stands upon can measure dynamic ground force data. There are other well-known apparatus and methods of measuring, modeling, and extracting salient data related to performed swings. Using these techniques, motion related information is collected and broken down to quantify, and characterize each elite golfer's swing into a first data set.

Second Data Set

Separately, a second set of data regarding personal characteristics of these elite golfers is determined. Some characteristics are physiological such as static physical parameters including limb lengths and ratios, BMI, and strength of various muscle groups. Additional anthropomorphic factors such as body-type, bow-leggedness, under-pronation (supination), and over-pronation can also be relevant. Other characteristics may be dynamic data collected involving prescribed motions. For example, subjects may be instructed to bend in various directions or to make a particular rapid but accurate arm motion. Included motions might be motions that are performed under load and those that are not loaded or with different degrees of load. Motions that involve biomechanically open kinetic chains and those that involve closed kinetic chains can be used. Specific demographic, mental and psychological data are collected. Objective psychological measurements include cognitive, executive function, attention, memory, and personality.

The large volumes of data in the first and second data sets are analyzed with non-linear techniques including artificial neural nets (ANN), self-organizing maps (SOM), machine learning classification trees, fuzzy classification, and other data mining techniques. In addition, analysis by regression, multivariate analysis and other more traditional statistical methods may be employed. These analyses can produce a clustering of associations between golf swing and personal characteristics.

After clusters are identified, a model swing can be created that reflects the most salient common characteristics of the measured swings of the elite golfers in a particular cluster. For teaching purposes, the model swing is broken down into sequence of teachable sub-components of motions, alignments, and forces that can be taught and learned, to achieve a successful swing execution. Each of the model or canonical swings associated with each relevant cluster is taught to multiple students to validate the conclusion of the cluster analyses.

### Exemplary Methods

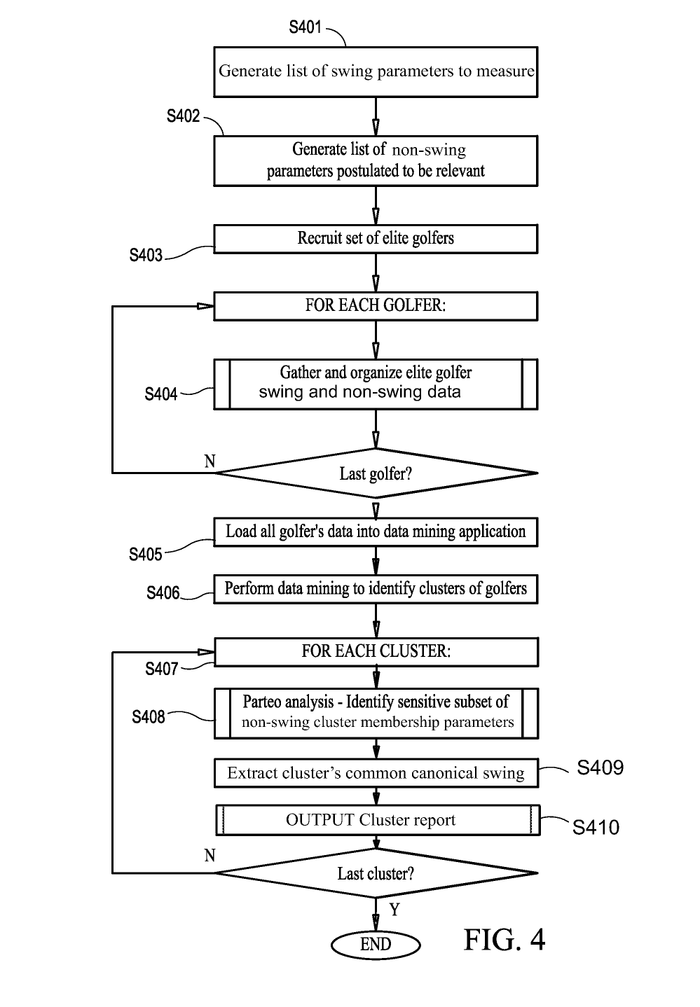

FIG. 4 is a flowchart of an overall process for creating a set of clusters of elite golfers grouped by common physiological and demographic characteristics and extracting a canonical swing common to the cluster. In step S401 a list of swing data parameters to be collected is created—these will make up the first data set. Then, using golf knowledge, a list of non-swing parameters to be collected is created S402. The non-swing parameters include motion parameters, non-motion physiological parameters, and physiological parameters. Other non-swing parameters can be biomechanical, anthropomorphic, demographic, and cognitive capabilities. These parameters will make up the second data set. A group of elite golfers representing a wide range of ages, body types, and swing styles is recruited S403.

Tests and measurements are performed S404 for each of the elite golfers to determine the information previously listed as relevant swing parameters in step S401 and non-swing parameters in step S402. When all the golfers' data of both the first data set and the second data set are collected and organized in a database, the data is fed S405 to a data mining software application. The data-mining activity has the goal of identifying S406 clusters of elite golfers with common demographic, physiological, non-physiological, and swing attributes.

For each cluster, do S407 the next step. A Pareto analysis is preformed S408 to identify particularly sensitive non-swing physiological parameters and non-physiological parameters that determine cluster membership most powerfully. Then a canonical swing based upon the common salient characteristics of the swing data of the cluster members is created S409, and broken down into teachable sub-components. A report for each cluster is output S410.

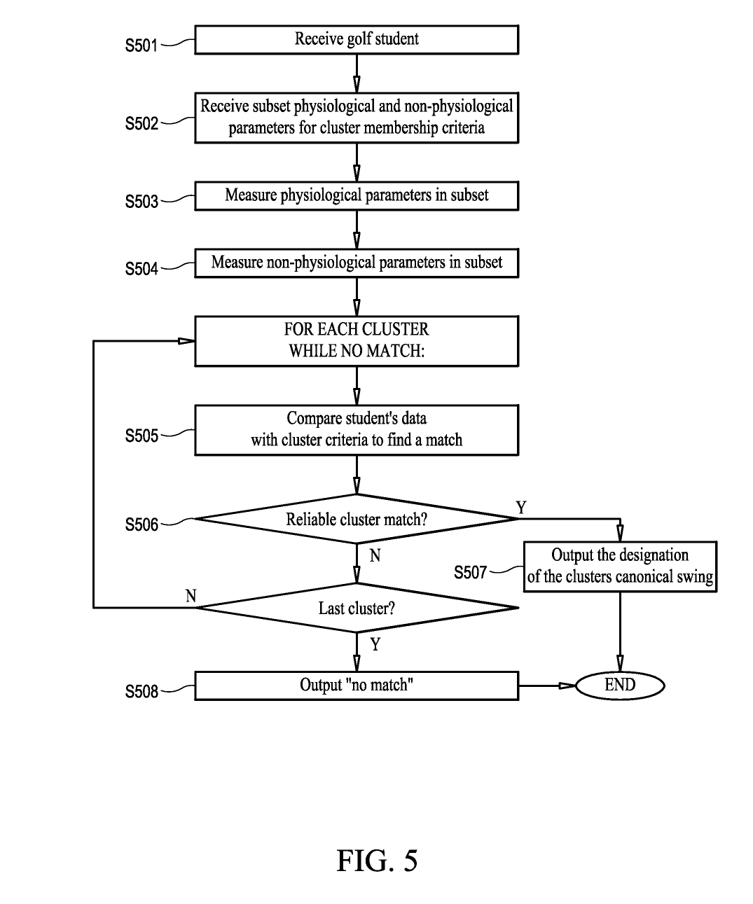

FIG. 5 is a flowchart of the process of associating a new golf student with one of the previously identified clusters. After receiving the student S501, the parameters important for cluster membership are received S502. The student's physiological and non-physiological information, corresponding to those parameters are gathered and measured S503 S504.

For each cluster, the student's information is compared to that cluster's criteria S505. If a reliable cluster match is found S506 the designation of that cluster is output S507. Otherwise, after comparison to all the clusters, “no match” is output S508.

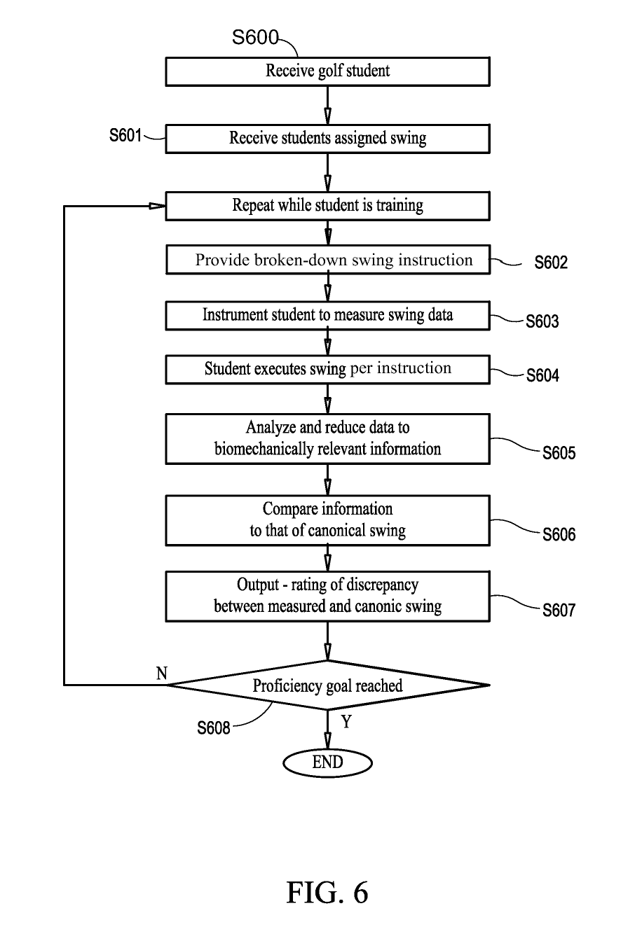

The flowchart of FIG. 6 shows the steps involved in training a student to execute the canonical swing they have been previously assigned. After receiving S600 the student and receiving student's assigned swing S601, the student enters a loop of testing and evaluation. The student is instructed S602 to perform the assigned swing in broken-down steps of motion, alignment and force. The student is instrumented S603 for motion and force and attempts to execute S604 the swing. The motion data collected during swing attempts is analyzed, and reduced to biomechanically relevant information S605. That biomechanical information is broken in to performance sub components and compared S606 to those of the canonical swing. Based on the sensitivity of each subcomponent and its performance discrepancy an overall figure of merit of mastering the swing is calculated. That overall figure of merit might be a scalar quantity such as a number between 1-100 or a letter grade such as A-F. The discrepancies are output S607 for use by the student and coach. The previous five steps are repeated until the student's proficiency goal is reached S608.

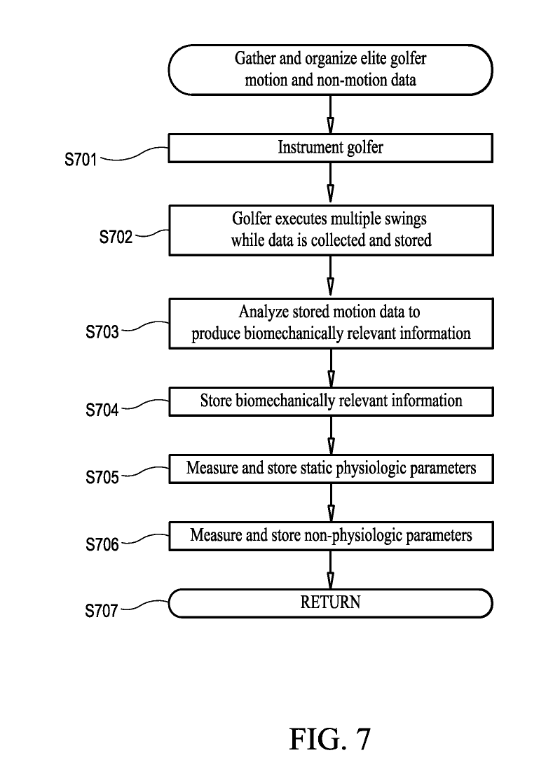

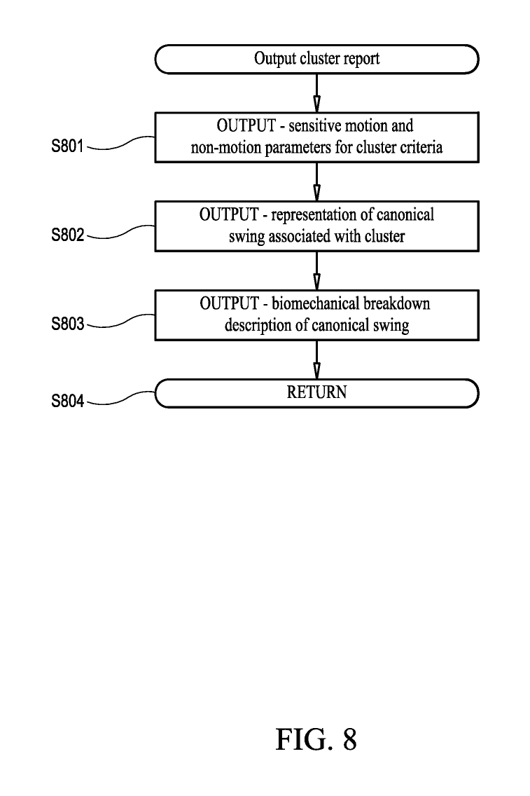

FIGS. 7 and 8 show sub processes of FIG. 4 in more detail. In FIG. 7 the sub process for Gathering and Organizing Elite Golfer Data is seen. The golfers are instrumented S701 for data collection while multiple swings are executed S702. That data is analyzed and transformed S703 to biomechanically relevant information that is stored S704. In addition, static physiological information S705 and non-physiological information S706 such as demographic and psychological information is gathered and stored. Psychological information can include objective psychological information such as cognitive ability, personality characteristics, executive functioning, and attention. Control is returned S707 to the main flowchart.

A simple sub-process for outputting a cluster report is seen in FIG. 8. The sensitive parameters for cluster membership are output S801; a representation of the cluster's associated canonic swing is output S802 A biomechanical breakdown of that swing is also output S803. Control is returned to the main flowchart S804.

Elite Golfers' Data Analyzed

Traditional statistical techniques that are useful in the data analysis steps include regression, multivariate analysis and principle component analysis (PCA). Those skilled in the art will be familiar with these mathematical approaches. They are shown applied in this art in U.S. Pat. No. 6,056,671, Manner; and Quantitative assessment of the control capability of the trunk muscles during oscillatory bending motion under a new experimental protocol, Kim, Parnianpour and Marras, Clinical Biomechanics vol. 11, no. 7, 385-391, 1996. Both references are hereby incorporated herein by reference in their entireties.

In many cases, the powerful, non-linear techniques of data mining including training artificial neural nets (ANN), self-organizing maps (SOM), machine learning classifier trees, and fuzzy decision trees are comprised in the data analysis. Those skilled in the art will be familiar with these computational approaches. They are shown applied in this art in US Published Patent Application 2005/0234309, Klapper and in U.S. Pat. No. 5,413,116, Radke et. al., and in U.S. Pat. No. 6,248,063, Barnhill. All three of these references are hereby incorporated herein by reference in their entireties.

### Students' Progress

Depending upon the analysis used and results obtained during database creation, the data produced while testing a student may be first pre-processed to extract features pre-determined to be salient. The data may be normalized in one or more dimensions. A rating or categorization may be assigned by linear calculation, by following a classification tree or by providing data to a trained learning machine.

While learning a new swing a student may be progressing steadily in their mastery of that new skill but in fact be producing erratic end-results. To coach or to self-coach, an objective measure of performance in learning that swing can be more useful than a golf score or even ball trajectory. Determining an overall figure of merit of a swing execution based on minimal measurements (for cost reasons and to reduce the intrusive instrumentation borne by the golfer) can give more valuable feedback to a student than the final outcome of ball.

Computer Systems

The data preparation system and data analysis and rating systems might be remotely located from each other. Alternatively, they might be co-located or might be implemented on a single computer server hardware. The computational devices used to carry out the method could be a personal computer or even a handheld device such as an iPhone for some system elements. In some versions of the system, it might prompt the subject to perform the limited set of motions. This might be via a text display, spoken output or preferably a video demonstration. In some cases, the subject and the computer performing the analysis might not be co-located. A central center of data analysis computation, trained computer learning systems and expertise may serve many student evaluation execution sites.

The following U.S. patent and other documents are hereby included herein by reference in their entirety to supplement the teaching herein and to reflect knowledge and techniques known to those proficient in the art. U.S. Pat. No. 5,823,878 Welch, monitor motions by video tape scenes from two or more angles; U.S. 2005/0272517 Funk, video system to compare a student's performance to images of a particular elite golfer; U.S. Pat. No. 6,565,448 Cameron, analysis of a golfers swing attributes; U.S. Pat. No. 7,264,554 Bentley teaches a wearable swing measurement outfit; US 2003/0054327 Evensen; “Weight Transfer Styles in the Golf Swing”, PhD. thesis by Kevin Ball 2006 Victoria University, AU; U.S. Pat. No. 7,041,014 Wright, matching a golfer with a golf club. Also incorporated herein in its entirety is “A three dimension kinematic and kinetic study of the golf swing”, Nesbit, Journal of Sports Science and Medicine (2005) U.S. Vol. 4, 499-519.

There are many techniques and technology known to those skilled in the art to make the relevant basic measurements. Those techniques include instrumenting a body with accelerometers, electronic compasses, EMG, strain gauges, etc. Other approaches include distinctive fiducial marks “watched” by a two or three-camera system, which can track each of the mark's movements in 3-dimensional space, over time. Techniques specific to golf swings are taught in “Three dimensional kinematic and kinetic study”, Journal of Sports Science and Medicine (2005) 4, 499-519 by Steven Nesbit, which is hereby incorporated by reference in its entirety.

These descriptions, figures and examples are intended to be non-limiting and to teach the principles and use. The claim below, in contrast, sets out the invention's metes and bounds. In the claims, the words “a” and “an” are to be taken to mean “at least one” even if some claim wording explicitly calls for “at least one” or “one or more.

Modules and Steps

The various illustrative program modules and steps described in connection with the embodiments disclosed herein may be implemented as electronic hardware, computer software, or combinations of both. The various illustrative program modules and steps have been described generally in terms of their functionality. Whether the functionality is implemented as hardware or software depends in part upon the hardware constraints imposed on the system. Hardware and software may be interchangeable depending on such constraints. As examples, the various illustrative program modules and steps described in connection with the embodiments disclosed herein may be implemented or performed with an application specific integrated circuit (ASIC), a field programmable gate array (FPGA) or other programmable logic device, discrete gate or transistor logic, discrete hardware components, a conventional programmable software module and a processor, or any combination thereof designed to perform the functions described herein. The processor may be a microprocessor, CPU, controller, microcontroller, programmable logic device, array of logic elements, or state machine. The software module may reside in RAM memory, flash memory, ROM memory, EPROM memory, EEPROM memory, hard disk, a removable disk, a CD, DVD or any other form of storage medium known in the art. An exemplary processor may be coupled to the storage medium so as to read information from, and write information to, the storage medium. In the alternative, the storage medium may be integral to the processor.

In further embodiments, those skilled in the art will appreciate that the foregoing methods can be implemented by the execution of a program embodied on a computer readable medium. The medium may comprise, for example, RAM accessible by, or residing within the device. Whether contained in RAM, a diskette, or other secondary storage media, the program modules may be stored on a variety of machine-readable data storage media, such as a conventional “hard drive”, magnetic tape, electronic read-only memory (e.g., ROM or EEPROM), flash memory, an optical storage device (e.g., CD, DVD, digital optical tape), or other suitable data storage media.

It is claimed:

1. A method of associating a model golf swing with a plurality of golfers' personal characteristics, comprising the following actions:
a. measuring golf swing data comprising one or more of: forces, positions, and motions of a plurality of golf swings performed by a plurality of elite golf players;
b. collecting a plurality of personal characteristics, respectively, of each of said plurality of golfers;
c. identifying clusters of associations between the measured swing data and the plurality of golfers' personal characteristics, using a computer having a processor and a memory;
d. determining, for at least one of the identified clusters, a canonical swing that is representative of commonalities of the swing data belonging to the cluster.

2. The method of claim 1 wherein the plurality of personal characteristics comprise static physical characteristics.

3. The method of claim 1 wherein the plurality of personal characteristics comprise dynamic physical characteristics.

4. The method of claim 1 wherein the plurality of personal characteristics comprise objective psychological characteristics.

5. The method of claim 1 wherein the measuring comprises the use of at least one of: an accelerometer, a ground force measurement pad, and a joint angle sensor.

6. The method of claim 1 further comprising the action of: breaking down the canonical swing into a sequence of teachable sub-components including at least one of motion, alignment, and force factors.

7. The method of claim 1 further comprising the actions of:
a. receiving a plurality of personal characteristics of a golf student, the personal characteristics including a subset of those collected from the plurality of golfers;
b. identifying the best matched cluster to the students' personal characteristics;
c. assigning the canonical swing associated with the best matched cluster to that student.

8. The method of claim 7 further comprising the action of providing the student instructional information regarding performance of the canonical swing, the instructional information comprising a breakdown of the canonical swing into subcomponents.

9. The method of claim 7 wherein the subset of personal characteristics are determined by a sensitivity analysis to cluster assignments.

10. A method of determining a golf swing to recommend to an individual comprising:
(a) comparing personal attributes of the individual to personal attributes of two or more clusters of elite golfers;
(b) selecting a cluster whose members have a positive correlation of their personal attributes with those of the individual;
(c) composing a swing, comprised of common aspects of swings of the cluster members, to recommend to the individual.

11. The method of claim 10 wherein the personal attributes comprise physical attributes.

12. The method of claim 10 wherein the personal attributes comprise mental attributes.

13. A method of teaching golf comprising the actions of:
a. gathering a plurality of personal characteristics of a golf student, the personal characteristics including physical attributes and objective physiological measurements;
b. assigning a model swing to the student based on a computer database of personal characteristics and golf swing performance measurements; the model swing being derived from swing performance measurements in the database associated with data from players with personal characteristic attributes congruent with those of the student.

14. The method of claim 13 wherein the plurality of personal characteristics further comprises mental characteristics.

15. The method of claim 13 wherein the plurality of personal characteristics further comprises demographic characteristics.

16. The method of claim 13 wherein the physical attributes include body-type.

17. A method of rating progress of a golf student learning a model swing comprising:
a. determining a golf student's golf swing performance on each of a plurality of sub-components of a model golf swing;
b. producing a weighted score of performance with the weighting of each of said sub-component's performance being proportional to its effect on a ball flight performance, using a computer system with a processor.

18. The method of claim 17 wherein the score comprises an overall scalar value.

19. A method of teaching golf comprising:
a. determining, via data analysis on a computer system with a processor, a commonality of a student's measured physical attributes with those of at least two high-performing golfers; the at least two high performing golfers having mutually similar swings;
b. assigning the student a model swing comprising mutually similar aspects of the at least two golfers' swings.

20. The method of claim 19 further comprising:
providing instructional information regarding steps for learning and practicing the model swing.

21. The method of claim 20 further comprising:
a. monitoring the student's progress toward mastering the model swing by collecting real-time measurements of at least one of the students motions or, the forces generated by the student, during a swing;
b. comparing biomechanically relevant aspects of the student's performance to that of the model swing.

22. The method of claim 21 further comprising the actions of:
a. calculating simulated ball flight based on swing measurements using a computer system with a processor;
b. producing an overall rating of student's ability to perform a model swing including biomechanically relevant aspects of the student's swing performance.
